(19) United States
(12) Patent Application Publication
(10) Pub. No.: US 2017/0146178 A1
(43) Pub. Date: May 25, 2017

(54) Method and Apparatus for Repairing a Pipe Junction

(71) Applicant: LMK Technologies, LLC, Ottawa, IL (US)

(72) Inventor: Larry W. Kiest, JR., Ottawa, IL (US)

(73) Assignee: LMK Technologies, LLC, Ottawa, IL (US)

(21) Appl. No.: 15/348,525

(22) Filed: Nov. 10, 2016

Related U.S. Application Data
(60) Provisional application No. 62/253,199, filed on Nov. 10, 2015.

(51) Int. Cl. F16L 55/179; F16L 55/165

(52) U.S. Cl. CPC F16L 55/179; F16L 55/165; F16L 41/021

(57) ABSTRACT

An assembly and method of sealing a junction of a pipe and a second structure are provided. The assembly includes a pipe liner having a tubular portion and a brim portion, a compression plate, and a mechanical anchor adapted to secure the compression plate and brim portion of the pipe liner to the second structure. The assembly may further include a gasket for placement between the pipe liner and the pipe or second structure. The gasket may comprise a hydrophilic material, a hydrophobic material, or a compressible material. The methods of using the assembly include, but are not limited to, the use of a cured-in-place pipe liner.

### CROSS REFERENCE TO RELATED APPLICATIONS

This application is based upon U.S. Provisional Application Ser. No. 62/253,199 filed Nov. 10, 2015, the complete disclosure of which is hereby expressly incorporated by this reference.

### FIELD OF THE INVENTION

The invention relates generally to a method and assembly for repair of junctions of tubes, passageways, conduits, or pipes. More particularly, but not exclusively, the invention relates to methods and devices for repairing a pipe junction with a mechanically-anchored compression plate to create a fluid-tight seal at the junction.

### BACKGROUND OF THE INVENTION

Many methods are currently known to rehabilitate or repair existing pipe junctions. For example, a cured-in-place pipe liner may be used to rehabilitate a pipe junction. Cured-in-place pipe liners are commonly used throughout the pipelining industry, and there are two common forms of cured-in-place pipe lining methods that have been used for the repair of the junction of a main and lateral sewer pipe. One cured-in-place system and method commonly used for the repair of such a junction is a brim-style junction liner, commonly referred to as a “top hat” system. This method of repairing a junction includes the use of a tubular pipe liner within the lateral portion of the junction, and the use of a flange or brim within the main portion of the junction. Examples of brim-style junction liner systems and methods are found in U.S. Pat. Nos. 5,393,481; 6,337,114; and 6,899,832.

A brim-style junction liner generally relies on adhesion to create a seal at the junction of a lateral and main pipe, as a curable resin is impregnated into the pipe liner and the impregnated liner is allowed to cure against the walls of the junction. The structural integrity of the lateral portion of the junction liner will remain intact for a long period after installation, as the tubular form will conform to the interior of the lateral pipe and provide reinforcement to the existing structure. However, in many known devices there is nothing to ensure the structural integrity of the brim portion, as it only conforms to a portion of the main pipe interior proximal to the junction, relying on an adhesive bond with the host pipe to ensure the integrity of the seal. U.S. patent application Ser. No. 13/429,060 (Kiest) filed on Mar. 23, 2012 discloses using a mechanical anchor such as a screw to help secure the brim portion to the interior of the main pipe. One problem with this device is that the mechanical anchors only secure the brim portion at a few selected locations thereby allowing much of the surface area of the brim portion to rely on the adhesive bond and not be mechanically secured to the interior of the pipe.

The second cured-in-place system and method commonly used for the repair of a junction is where the cured-in-place pipe liner includes a tubular lateral pipe liner within a portion of the lateral pipe and a tubular pipe liner within the full circumference of the main pipe. Patents directed at these systems include U.S. Pat. Nos. 5,950,682; 6,039,079; 6,105,619; and 6,994,118. There are many advantages to using such a system, including enhanced structural properties around the junction, decreased risk of junction renewal failure, and enhanced sealing properties. However, because the portion of the pipe liner in the main pipe covers the full circumference of the main pipe, there may be a chance of flow disruption within the main pipe near the junction with the lateral pipe in certain embodiments of the system. Additionally, the resins used in cured-in-place pipelining are subject to polymerization shrinkage, increasing the risk of the seal being breached after installation within the pipe junction.

Accordingly, there is a need in the art for an improved pipe liner assembly for a pipe junction that overcomes the problems of inadequate sealing area and inadequate attachment to the junction to be sealed, while minimizing the chances of flow disruption in the pipeline and creating a fluid-tight seal.

### SUMMARY OF THE INVENTION

It is therefore an object of the present invention to provide an improved assembly and method for sealing a junction of pipes, conduits, or other structures using a compression plate to help secure a liner inside a pipe.

It is another object, feature, and/or advantage of the present invention to provide an improved assembly and method for sealing a junction of pipes, conduits, or other structures using a compression plate to help secure a brim-style junction liner wherein the brim portion of the liner is a resin impregnable material.

It is another object, feature, and/or advantage of the present invention to provide an improved assembly and method for sealing a junction of pipes, conduits, or other structures using a compression plate to help secure a brim-style junction liner wherein the brim portion of the liner is made from a material different than the lateral portion of the liner and the brim portion of the liner is not resin impregnable. The liner is held in place by the mechanically anchored compression plate so it does not depend on resin bonding to the brim of the liner or to the structure to help hold it in place.

It is another object, feature, and/or advantage of the present invention to provide an improved assembly and method for sealing a junction of pipes, conduits, or other structures using a compression plate to help secure a tubular liner where the liner does not have a brim but instead is combined with the compression plate and/or gasket near the junction such that those components function as the brim.

It is another object, feature, and/or advantage of the present invention to provide a junction liner that is easy to manufacture at a low cost.

It is another object, feature, and/or advantage of the present invention to provide a seal at a junction of a pipe and another structure that prevents seal design failures by utilizing a mechanical anchor that travels at least partially through a compression plate and the structure to be sealed. In some embodiments, the compression plate is positioned adjacent to the brim portion of a liner and at least a portion of the anchor is driven through the compression plate and the brim portion of the liner to ensure the integrity of the seal. In other embodiments, the tubular liner does not have a brim portion and the compression plate and/or gasket is secured to the tubular liner near the junction such that those components function as the brim.

It is another object, feature, and/or advantage of the present invention to provide an improved method and apparatus for repairing the junction of a main and lateral pipe that utilizes gaskets to prevent leakage at the penetration points of the mechanical anchors.

It is another object, feature, and/or advantage of the present invention to provide an improved method and apparatus for repairing the junction of a main and lateral pipe that provides a compression seal to the majority of the area at the main and lateral junction.

These and/or other objects, features, and advantages of the present invention will be apparent to those skilled in the art. The present invention is not to be limited to or by these objects, features and advantages, and no single embodiment need exhibit every object, feature, and/or advantage.

According to one aspect of the present invention, an assembly for sealing a junction of a pipe and a second structure is provided. The assembly includes a pipe liner having a tubular portion and a brim portion and a compression plate positioned adjacent to the brim portion of the liner. A mechanical anchor is adapted to secure the compression plate and brim portion of the pipe liner to the second structure. In some embodiments the brim portion of the liner is made from a material different than the tubular portion. In some embodiments the brim portion is not resin impregnable. The assembly may further include a gasket or other type of seal (collectively referred to herein as a “gasket”) for placement between the pipe liner and the pipe or second structure. The gasket may comprise a hydrophilic material, a hydrophobic material, a paste, or a compressible material. In some embodiments the tubular portion of the liner does not include a brim portion. Instead, the tubular liner is combined with either the compression plate or the gasket before securing the compression plate to the wall with a mechanical anchor such that those components function as the brim.

According to another aspect of the present invention, an apparatus and method for sealing a junction of a pipe and a second structure is provided which does not use a liner. The apparatus includes a gasket and a compression plate. These components may have a brim portion shaped like a donut or they may comprise a brim portion combined with a tubular portion. The brim portion of the gasket is placed against an interior wall of the second structure and the brim portion of the compression plate is placed against the brim portion of the gasket so that gasket is between the compression plate and the wall. The compression plate is secured to the wall using a mechanical anchor. In embodiments where the components include a brim portion and a tubular portion, the tubular portion of the gasket is placed against an interior wall of the second structure and the tubular portion of the compression plate is placed against the tubular portion of the gasket so that the gasket is between the tubular portion of the compression plate the wall.

According to another aspect of the present invention, a method of sealing a junction of a pipe and a second structure is provided. The method includes providing a pipe liner having a tubular portion and a brim portion and a compression plate. The tubular portion of the pipe liner is placed against an interior wall of the pipe and the brim portion is placed against the second structure. The compression plate and brim portion are secured to the second structure using a mechanical anchor so that the brim portion is compressed against the second structure by the compression plate. The method may further include placing a gasket between the brim portion of the pipe liner and the second structure, and inserting the mechanical anchor through the gasket and at least partially through the second structure.

### BRIEF DESCRIPTION OF THE DRAWINGS

FIG. 1A is a sectional view of a brim-style junction liner shown installed at a junction of a main sewer pipe and a lateral sewer pipe.

FIG. 1B is a perspective view of a brim-style junction liner shown installed at a junction of a main sewer pipe and a lateral sewer pipe showing the liner inside the pipe.

FIG. 2A is a perspective view of an embodiment of a brim-style junction liner configured for installation at a tee junction prior to installation within a pipe.

FIG. 2B is a perspective view of an embodiment of a brim-style junction liner configured for installation at a wye-junction prior to installation within a pipe.

FIG. 3 is a sectional view of a brim-style junction liner and a compression plate installed at the junction of a pipe and a second structure where a mechanical anchor is installed through the components and at least partially through the second structure.

FIG. 4 is a sectional view of a brim-style junction liner, a gasket, and a compression plate installed at the junction of a pipe and a second structure where a mechanical anchor is installed through the components and at least partially through the second structure.

FIG. 5 is a sectional view of brim-style junction liner, a gasket, and compression plate installed at the junction of a pipe and a second structure where the brim portion of the liner is made from a material different than the tubular portion of the liner and a mechanical anchor is installed through the components and at least partially through the main sewer pipe.

FIG. 6 is a sectional view of a gasket and compression plate installed at the junction of a pipe and a second structure where at least one of the compression plate and the gasket are attached to the tubular liner to function as the brim and a mechanical anchor is installed through the components and at least partially through the main sewer pipe.

FIG. 7 is a perspective view of the compression plate.

FIG. 8 is a perspective view of a compression plate having a brim portion and a tubular portion.

FIG. 9 is a sectional view of a gasket and compression plate installed at the junction of a pipe and a second structure where both components include only a brim portion.

FIG. 10 is a sectional view of a gasket and compression plate installed at the junction of a pipe and a second structure where both components include a brim portion and a tubular portion.

### DETAILED DESCRIPTION OF EMBODIMENTS

The present invention is directed towards an assembly and method for sealing a junction between tubes, passageways, conduits, or pipes. Embodiments of the invention include a pipe liner 20 having a tubular portion 24 and a brim portion 22 and a compression plate 34. The tubular portion of the pipe liner 20 is placed against an interior wall of the pipe 12 and the brim portion 22 is placed against the second structure 10. The compression plate 34 and brim portion 22 are secured to the second structure 10 using a mechanical anchor 32 so that the compression plate 34 compresses the brim portion 22 against the second structure 10. The method may further include placing a gasket 29 between the brim portion 22 of the pipe liner 20 and the second structure 10. The mechanical anchor 32 may be inserted through the gasket 29 and at least partially through the second structure 10. In some embodiments the mechanical anchor 32 is inserted through the compression plate 34 but not through the gasket 29 because the gasket 29 may have a smaller diameter than the portion of the compression plate 34 receiving the mechanical anchor 32. In these embodiments the compression plate 34 applies force against the gasket 29 to help hold the gasket 29 in place. The method may further include a pipe liner 20 having a tubular portion 24 but no brim portion. In this embodiment the tubular portion 24 is combined with the compression plate 34 and/or the gasket 29 before the compression plate 34 is secured to the second structure 10 such that those components function as the brim.

The illustrated embodiments are described primarily in reference to junctions of sewer pipes. However, many other types of junctions are intended to be within the scope of this invention, including but not limited, to pipe/manhole junctions, gravity pipe junctions, pressure pipe junctions, water pipe junctions, and oil/gas pipe junctions. Some illustrated embodiments show where the liner utilized is a cured-in-place liner. However, it should be understood that the use of other types of pipe liners are within the scope of this invention. For example, the pipe liner may be a cured-in-place liner, a folded liner, or a spray-on liner, as long as a seal is to be created at the junction with a brim portion adjacent the tubular pipe liner. Further, the liner 20 may be positioned in the pipe 12 using any conventional method, including inversion methods and pull-in-place methods.

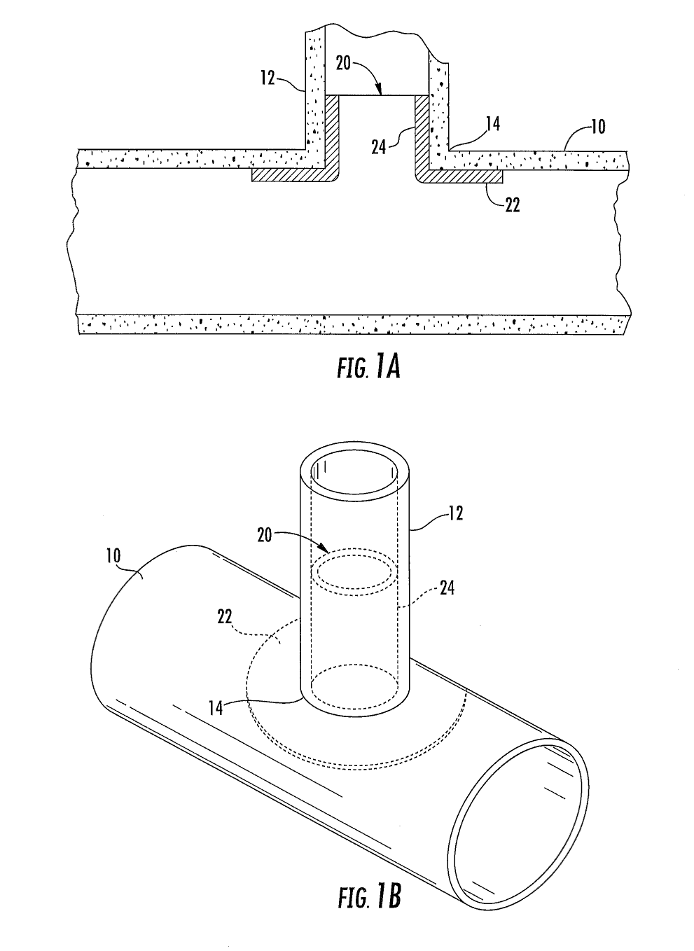

Referring now to the drawings, wherein like numerals refer to like parts, FIG. 1A is a sectional view of one embodiment of a brim-style junction liner 20 shown installed at the junction 14 of a second structure 10 such as a main sewer pipe and a pipe 12 such as a lateral sewer pipe. Some embodiments of the present invention include the use of a brim-style junction liner 20 that includes a tubular portion 24 within the pipe 12 adjacent the junction 14, and a flange or brim portion 22 within the second structure 10 adjacent the junction 14. FIG. 1B shows the same assembly of FIG. 1A, depicted as a perspective view showing internal components in dashed lines, wherein the brim-style junction liner 20 is shown installed at a junction 14 of a second structure 10 such as a main sewer pipe and a pipe 12 such as a lateral sewer pipe. As explained below, some embodiments include a gasket 29, 30 and a compression plate 34, but not a liner 20.

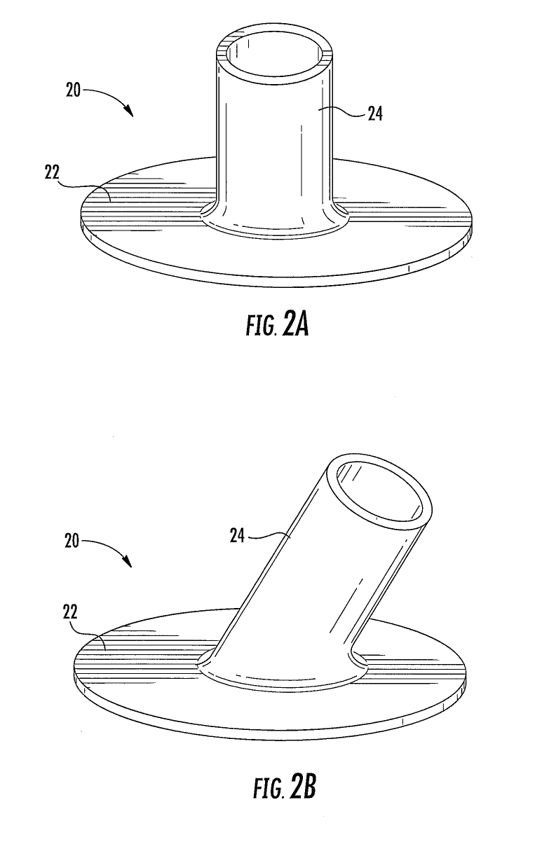

FIGS. 2A-2B depict perspective views of an embodiment of a brim-style junction liner 20 prior to installation within a pipe. FIG. 2A shows a brim-style junction liner 20 configured for installation within a standard tee-junction, and FIG. 2B shows a configuration for installation within a wye-junction. A tee junction of a pipe and a second structure may be generally described as a junction where the pipe joins the second structure at approximately a 90-degree angle. A wye-junction of a pipe and a second structure may be generally described as a junction where the pipe joins the second structure at an angle greater or less than approximately 90-degrees. As shown in the figures, the brim-style liner junction liner 20 comprises a tubular portion 24 and a brim portion 22. According to an embodiment of the present invention, a brim 22 is considered to be a projecting rim or edge extending outwardly from the tubular portion. In the embodiment of FIGS. 2A-2B, the tubular portion 24 and brim portion 22 of the brim-style junction liner 20 are a single, unitary piece that may be constructed by a variety of methods.

For example, in some embodiments the brim-style junction liner 20 may be a cured-in-place liner comprising a fabric capable of holding a resinous material capable of curing and hardening. The fabric of the brim-style junction liner 20 may be knitted or otherwise formed as a single piece into the configurations shown in FIGS. 2A-2B. The brim-style junction liner 20 may alternatively be formed by attaching the tubular portion 24 to the brim portion 22. In such an embodiment, the tubular portion 24 may be formed by cutting a flat sheet of fabric to a specified size, forming the flat sheet into a tube, and sealing the ends of the sheet by stitching, adhesives, curable laminate films, flame bonding, heat welding, any combination of the foregoing, or the like. The brim portion 22 is formed by cutting a hole into a sheet of fabric. The sheet may be many shapes, but an annular shape is preferred, with the diameter of an inner circle of the annulus similar to the diameter of the tubular portion 24. An end of the tubular portion 24 is joined to the brim portion 22 at the inner circle of the annulus by stitching, adhesives, curable laminate films, flame bonding, heat welding, any combination of the foregoing, or the like.

One or more surfaces of the fabric of the brim-style junction liner 20 include a polymeric coating comprising an impervious polymeric coating or film, preferably a thermoplastic polyurethane (“TPU”). The coating may be made of other polymeric materials, such as polyethylene (PE) or polyvinyl chloride (PVC). However, the polymeric coating may be any other polymer that can be coated onto a resin-absorbent fabric. For example, some polymers that may be used to coat an absorbent fabric include polyurethanes, polyethylenes, polyvinylchlorides, butyls, rubbers, cellophane nitrates, neoprenes, polyester, or combinations thereof. A TPU is preferred because TPU is an example of a polymeric material that may be left inside the junction after the lining process is complete, acting as a coating to the interior of the conduit. It should also be noted that the coating is not a requirement of the present invention, it is contemplated that the liner need not include any such coating on either side of the liner.

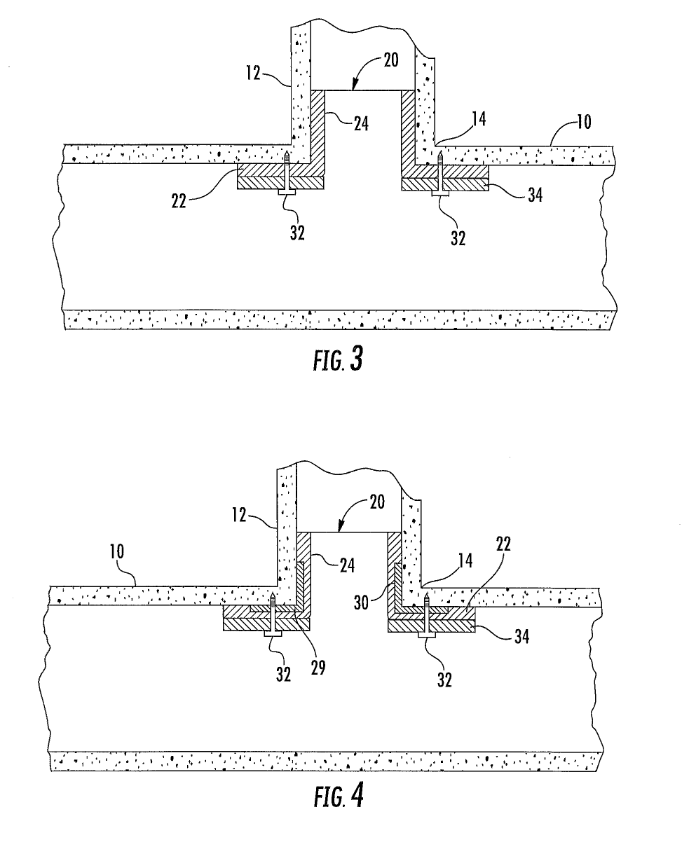

FIG. 3 is a sectional view of a junction 14 of a pipe 12 and a second structure 10, where a brim-style junction liner 20 having a brim portion 22 and compression plate 34 have been installed and mechanical anchors 32 have been driven through the components 22, 34 and at least partially into the wall of the second structure 10. The pipe 12 may be a sewer pipe, a service pipe, a gas pipe, a pressure pipe, or any other conduit adjoined at a junction with a second structure. The second structure 10 may be a manhole wall, a pipe, a service pipe, a gas pipe, a pressure pipe, or any other structure adjoined with a pipe. For convenience the pipe 12 is generally depicted herein as a lateral pipe and the second structure 10 is generally depicted herein as a main pipe.

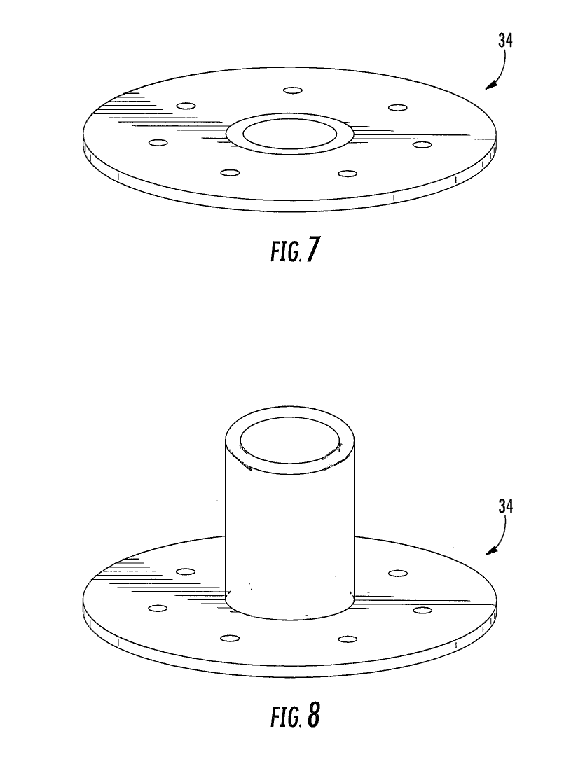

The brim portion 22 includes a first side facing the wall of the second structure 10 and a second side facing the compression plate 34. The compression plate 34 is positioned farthest from the wall of the second structure 10 so that the brim 22 is compressed between the second structure 10 and the compression plate 34. FIGS. 7 and 8 show perspective views of embodiments of the compression plate 34 separated from the rest of the assembly wherein the compression plate 34 includes pre-drilled openings adapted to receive the mechanical anchors 32. The compression plate 34 may be ring or donut shaped as shown in FIG. 7 or it may have a brim portion combined with a tubular portion as shown in FIG. 8, similar to the shape of the liner 20 shown in FIG. 2A. The compression plate 34 is secured to and driven toward the second structure by one or more the mechanical anchors 32. The compression plate 34 may be any suitable size and shape, however, in one embodiment its size and shape approximate the size and shape of the brim portion 22 and/or the size and shape of the lower portion of the gasket 29 (in embodiments which use gaskets). The compression plate 34 is made from a rigid or semi-rigid material, preferably a metal such as stainless steel. The rigidity of the compression plate 34 helps apply force to and secure the components against the wall of the second structure even in areas away from the mechanical anchors 32 by distributing the force of the mechanical anchors 32 across the entire surface of the brim portion 22 and/or gasket 29 that is in contact with the compression plate 34. In embodiments described below the compression plate 34 helps secure the components to the second structure even when the brim portion of the liner 20 is not impregnated with resin through the distribution of force around a circumference of the entire brim portion 22 and/or gasket 29.

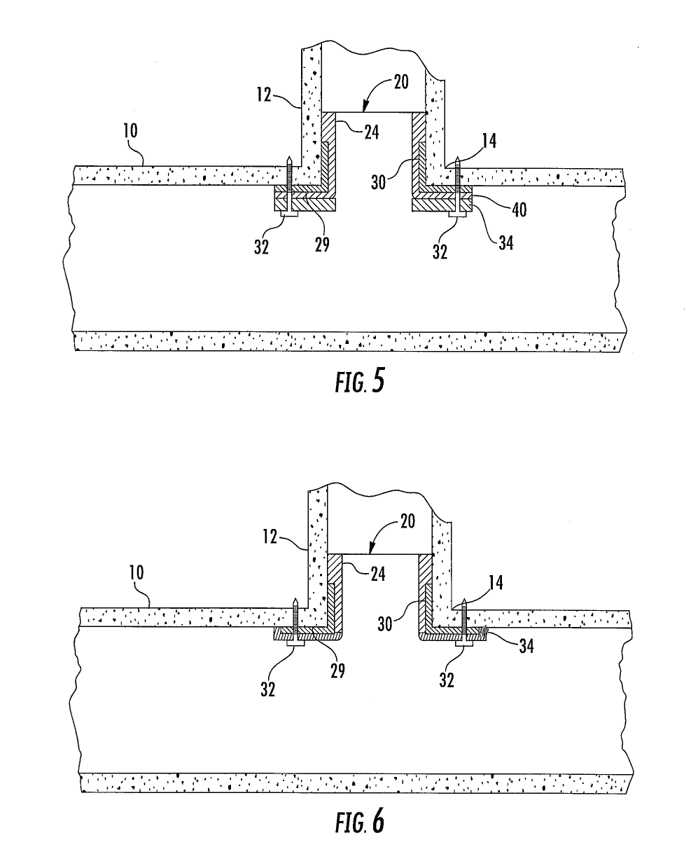

It should be noted that in some embodiments the mechanical anchors 32 do not penetrate through the entire thickness of the second structure 10. Put another way, the mechanical anchors 32 do not extend through both sides of the second structure as shown in FIGS. 3 and 4. Such a configuration is preferred in this embodiment to prevent leakage of fluid within the junction at the penetration points of the mechanical anchors 32. Accordingly, a mechanical anchor 32 having a length less than the thickness of the brim portion 22, compression plate 34, and second structure 10 is utilized in this embodiment. Where the mechanical anchors 32 penetrate the wall of the second structure 10 completely, the incorporation of a gasket material is preferred as described in reference to subsequent embodiments as shown in FIGS. 5 and 6.

Depending on the accessibility of the second structure 10, the mechanical anchors 32 may be installed by a variety of methods. If the second structure 10 is generally accessible to a tool operator (such as via a manhole), then a drill, hammer, ratchet, screwdriver, or other tool may be used to drive the mechanical anchors 32 at least partially into the wall of the second structure 10, securing the brim portion 22 to the wall of the second structure 10. In such an embodiment, the mechanical anchor 32 may be a screw, nail, rivet, or other fastener adapted to secure two components. For example, if the second structure includes a wall comprising concrete, any anchor capable of penetrating and securing a compression member and/or liner to the wall of the second structure may be used.

Alternatively, other mechanical anchors may be used to secure the components to the second structure 10. For example, an anchor nail may be used as the mechanical anchor 32. For such an application, the anchor nail comprises a nail body including anchor nubs that run the length of the nail body, and a flange portion. As in the previous embodiment, the brim-style junction liner is placed at a junction using methods known in the art. The anchor nail is driven through the components and at least partially through the second structure 10 by imparting a force on the flange of the nail in the direction of the host pipe using a driver tool. A driver tool for use in this embodiment may be a hammer or an auto hammer. The driver tool may be secured to a robot for use in pipelining applications where the pipe diameter restricts operator access to the junction. For instance, U.S. Pat. Nos. 6,031,371; 6,101,951; and 7,720,570 (hereby incorporated by reference in their entireties) disclose robots designed for pipelining or sewer applications with the capability for including interchangeable tools on board the robot. Such a driver tool may optionally be fitted to automatically re-load a mechanical fastener while within the pipeline. Alternatively, an operator may manually re-load the driver tool after each anchor is installed near the junction.

In the embodiment shown in FIG. 3, the brim portion 22 of the liner 20 is combined with the tubular portion 24 of the liner 20 and both portions 22, 24 are made from a resin impregnable material. The brim-style junction liner 20 may be a cured-in-place pipeline that has been installed at the junction 14 using a cured-in-place pipelining technique such as inversion or pull-in-place methods. In cured-in-place pipelining, a bladder or other inflation member is used to press the liner against the pipe walls. A liner is impregnated with a resinous material capable of curing and hardening and secured with the bladder or inflation member. The liner, bladder, and placement device are positioned near the junction and the bladder is inflated, pushing the resin-impregnated liner against the walls of the junction. The resinous material is then cured and allowed to harden, creating a new interior of the junction.

FIG. 4 shows an embodiment where a gasket 29, 30 is placed between the brim-style junction liner 20 and the wall of the main and lateral pipes 10, 12. This allows a seal to be created between the walls of the junction 14 and the brim-style junction liner 20. As shown, where the brim-style junction liner 20 is a cured-in-place pipe liner, prior to or after the resinous material curing and hardening, the mechanical anchors 32 are placed through the gasket 29 and at least partially into or through the second structure 10. In some embodiments it is not necessary for the mechanical anchors 32 to be placed through the gasket 29, for example, in embodiments where the diameter of the gasket 29 is smaller than the diameter of the compression plate 32. In these embodiments the force of the compression plate 32 toward the second structure/main pipe 10 is enough to secure the gasket 29 in place.

In one embodiment the gasket 29 is ring or donut shaped so that it is compressed against the second structure 10/main pipe but does not extend into pipe 12. In another embodiment the gasket includes an upper portion 30 and a lower portion 29 similar to the shape of the brim-style junction liner 20 described above, wherein the upper portion 30 extends at least partially into the pipe 12 and the lower portion 29 extends at least partially into the second structure 10. This configuration of the gasket 29 provides a compression seal to the majority of the area at junction 14, effectively sealing the entire area that is high risk for fluid infiltration. It should be understood that the configuration of the gasket 29 is for illustrative purposes, and other configurations of the gasket 29 are contemplated for use with this invention. For instance, the gasket 29 could be ring-shaped, pleased on or attached directly to the brim-style junction liner 20, and positioned between the brim-style junction liner 20 and the main sewer pipe 10 or lateral sewer pipe 12. The upper portion 30 and lower portion 29 of the gasket may be formed as one unitary member or the two portions 29, 30 may be physically separate components that are installed adjacent to each other so that they function together to form a seal at the junction 14.

The gasket 29, 30 comprises a compliant, compressible, impermeable material including, but not limited to, rubber, polyurethane, or other compliant polymers. Gasket 29, 30 may also be made of or impregnated with a material having hydrophilic properties, such that the material will swell in the presence of water. Such a material is preferred when the junction to be sealed experiences or is at risk of experiencing consistent water infiltration, as the hydrophilic gasket will expand in the presence of water and extrude through voids or cracks in the passageway, thus creating a full compression seal. For examples of hydrophilic materials for use as seals, see U.S. Pat. Nos. 6,328,310; 6,541,106; or 6,994,118. Alternatively, or in combination, the gasket 29, 30 may be constructed of or coated in a hydrophobic material to repel the water from the junction under normal or dry conditions. As the mechanical anchors 32 illustrated in FIG. 4 travel through the brim portion 22, any seal created by the brim-style junction liner 20 will be breached at the location of the anchors. Therefore, the gasket 29, 30 will swell in the presence of water, negating the leaking effect created by insertion of the mechanical anchors 32. Alternatively, or in combination, the gasket may be formed from a hydrophilic paste or other sealing material.

The operation of the embodiment depicted in FIG. 3 is as follows. The brim-style junction liner 20 is impregnated with a resinous material capable of curing and hardening. The upper portion 30 of a gasket is placed against the wall of a lateral sewer pipe 12 and the lower portion 29 of the gasket is placed against the wall of a main sewer pipe 10 such that the interior of the junction 14 is covered by the gasket. A brim-style junction liner 20 having a brim portion 22 and a tubular portion 24 is placed over the gasket, such that the brim-style junction liner 20 extends beyond the gasket in both the main and lateral pipes. A compression plate 34 is then placed over the brim portion 22. Mechanical anchors 32 are inserted through the compression plate 34, brim portion 22 of the brim-style junction liner 20, and the lower portion 29 of the gasket, and at least partially into the main sewer pipe 10. It is preferred to use a plurality of mechanical anchors 32 at diametrically opposed installation sites with respect to the junction diameter to evenly distribute the force across the entire surface of the compression plate 34. Such a configuration of mechanical anchors 32 will decrease the chance of weak points developing along the brim portion 22, breaching the seal. For example, as the brim portion 22 of the liner is generally circular shaped, it is contemplated that a number of mechanical anchors 32 will be inserted through the brim and spaced radially about the axis of the brim. If not already positioned, the tubular portion 24 of the liner 20 is pulled into place or inverted into the pipe 12. The brim-style junction liner 20 is pressed against the walls of the second structure/main sewer pipe 10 and the pipe/lateral sewer pipe 12 under fluid pressure, and the resinous material capable of curing and hardening is allowed to cure and harden.

FIG. 5 shows a sectional view of a brim-style junction liner 20 having a brim portion 40 and a tubular portion 24 installed in conjunction with a compression plate 34 at a junction 14 of a pipe 12 and a second structure 10. FIG. 5 also shows a gasket 29, 30, however, the gasket 29, 30 is not a required component for this embodiment. This embodiment is similar to the embodiment shown and described with respect to FIG. 4, except the brim portion 40 of the liner 20 is made from a material different than the tubular portion 24. The brim portion 40 is made from a material that is not resin impregnable and is preferably made from a polymer such as urethane. Mechanical anchors 32 are installed through the components and at least partially through a wall of the second structure 10. The compression plate 34 provides rigidity and helps secure the brim 40 to the second structure even though there is no resin bond between the brim 40 and the second structure 10.

FIG. 6 shows a sectional view of an alternate embodiment wherein the liner 20 does not include a brim portion. FIG. 6 also shows a gasket 29, 30, however, the gasket 29, 30 is not a required component for this embodiment. In this embodiment, the tubular portion 24 of the liner 20 is combined with the compression plate 34 and/or the gasket 29, 30 near the junction 14 such that the compression plate 34 and/or gasket 29 function as the brim of the liner 20. Mechanical anchors 32 are installed through the components and at least partially through a wall of the second structure 10. The compression plate 34 provides rigidity and helps secure the liner 20 in place even though the liner 20 does not have a brim portion.

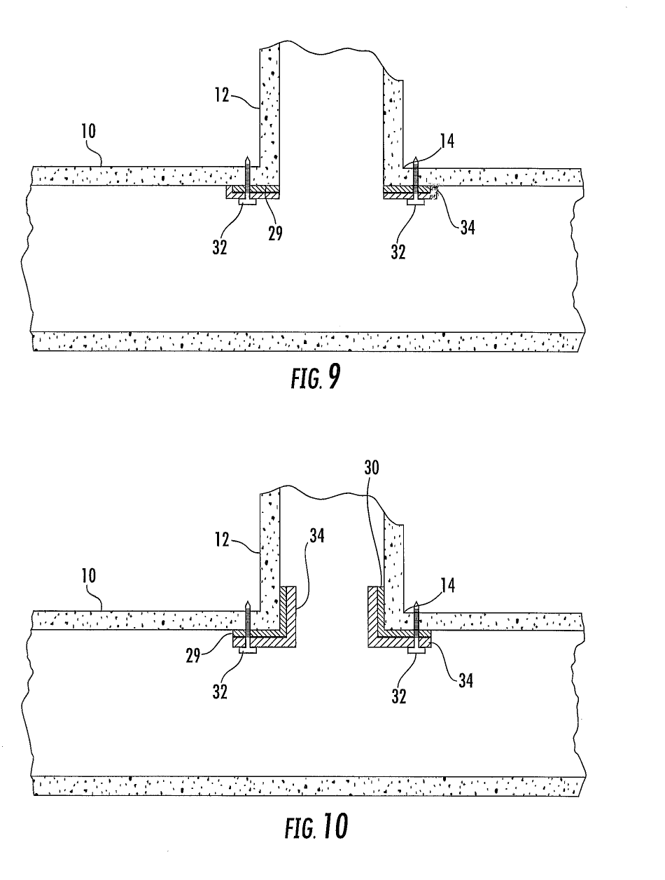

FIGS. 9 and 10 show sectional views of alternate embodiments that do not use a liner 20. Instead, a gasket 20, 30 is placed against the pipe 12 and/or second structure 10 and secured by a compression plate 34. The gasket may be a brim 29 that is ring or donut shaped or it may have a tubular portion 30 combined with a brim 29. A compression plate 34 is secured to the second structure 10 using a mechanical anchor 32 so that the compression plate 34 compresses the brim portion 22 against the second structure 10 as explained above. FIG. 9 shows an embodiment wherein the gasket 29 and compression plate 34 are both ring/donut shaped and combined with the second structure 10/main pipe near the junction 14 of the second structure 10 and the pipe 12. FIG. 10 shows an embodiment wherein the gasket 29, 30 and compression plate 34 each include a tubular portion and a brim portion. In this embodiment the tubular portion of both elements extends into the pipe 12 and the brim portion is combined with the second structure 10/main pipe near the junction 14 of the second structure 10 and the pipe 12. The tubular portion of the compression plate 34 provides a rigid structure for the tubular portion 30 of the gasket to compress against in the event that the gasket swells. In other words, the tubular portion 30 of the gasket is positioned between the wall of the pipe 12 and the rigid tubular portion of the compression plate 34 to compress and limit the expansion of the gasket in the event the gasket begins to swell.

In operation of an embodiment of the invention, a junction of a pipe 12 and a second structure 10 is sealed. First, the junction is visually inspected by a technician or operator either manually or with the aid of a closed-circuit television (“CCTV”) camera system. Once the condition of the junction is assessed, a brim-style pipe liner 24 is provided having dimensions that generally conform to the dimensions of the junction. The pipe liner 24 is then placed against an interior wall of the pipe 12, placing the brim portion against the second structure. A compression plate 34 is placed on the brim portion. The compression plate 34 and brim portion are secured to the second structure using a mechanical anchor 32. The mechanical anchor 32 should pass at least partially through the second structure 10. Optionally, a gasket 29, 30 may be placed between the brim portion of the pipe liner 24 and the second structure 10. In some embodiments the mechanical anchor 32 passes through the gasket 29, 30 in other embodiments it does not. Alternatively, a gasket (not shown) may be placed between a shoulder of the mechanical anchor 32 and the pipe liner 24 to help prevent leakage at the point where the mechanical anchor 32 is driven through the components.

It should be understood that various changes and modifications to the present embodiments described herein would be apparent to those skilled in the art. Such changes and modifications may be made without departing from the spirit and scope of the present invention and without diminishing its attendant advantages. It is, therefore, intended that such changes and modifications be covered by the appended claims.

What is claimed is:

1. An assembly for sealing a junction of a pipe and a second structure comprising:
a pipe liner having a tubular portion and a brim portion;
a compression plate adjacent to the brim portion of the pipe liner; and
a mechanical anchor adapted to secure the compression plate and the brim portion of the pipe liner to the second structure.

2. The assembly of claim 1, further comprising a gasket for placement between the pipe liner and the pipe or second structure.

3. The assembly of claim 2, wherein the gasket comprises a hydrophilic material or a hydrophobic material.

4. The assembly of claim 2, wherein the gasket comprises a compressible material.

5. The assembly of claim 1, wherein the pipe is a lateral sewer pipe and the second structure is a main sewer pipe.

6. The assembly of claim 5, wherein the mechanical anchor comprises a screw, a nail, or a rivet.

7. The assembly of claim 1 wherein the brim portion of the pipe liner is positioned between the second structure and the compression plate

8. The assembly of claim 1, wherein the pipe liner is a cured-in-place pipe liner.

9. The assembly of claim 1 wherein the compression plate comprises a metal.

10. The assembly of claim 1 wherein the brim portion has a size and shape and the compression plate approximates the size and shape of the brim portion.

11. The assembly of claim 1 wherein the tubular portion and the brim portion are both resin impregnable.

12. The assembly of claim 1 wherein the tubular portion is resin impregnable and the brim portion is not resin impregnable.

13. The assembly of claim 1 wherein the tubular portion is made from a material different than a material of the brim portion.

14. The assembly of claim 1 wherein the brim portion is the compression plate.

15. The assembly of claim 2 wherein the brim portion is the gasket.

16. A method of sealing a junction of a pipe and a second structure comprising:
providing a pipe liner having a tubular portion and a brim portion and a compression plate;
placing the tubular portion of the pipe liner against an interior wall of the pipe;
placing the brim portion against the second structure;
placing the compression plate against the brim portion; and
securing the compression plate and brim portion to the second structure using a mechanical anchor.

17. The method of claim 16, further comprising securing the mechanical anchor to a gasket.

18. The method of claim 17, further comprising placing a gasket between the brim portion of the pipe liner and the second structure.

19. The method of claim 17, wherein the gasket comprises a hydrophilic material, a hydrophobic material, or a compressible material.

20. The method of claim 16, wherein the pipe is a lateral sewer pipe and the second structure is a main sewer pipe.

21. The method of claim 16 further comprising the step of compressing the brim portion of the pipe liner between the second structure and the compression plate.

22. The method of claim 16, wherein the pipe liner is a cured-in-place pipe liner.

23. The method of claim 22, wherein the securing step comprises driving the mechanical anchor through the brim portion and at least a portion of the second structure after a resin impregnated within the cured-in-place pipe liner has hardened.

24. The method of claim 23, further comprising inserting the mechanical anchor through a gasket placed between the brim portion of the pipe liner and the second structure.

25. The method of claim 24, wherein the pipe is a lateral sewer pipe and the second structure is a main sewer pipe.

26. The assembly of claim 16 wherein the compression plate comprises a metal.

27. The assembly of claim 16 wherein the brim portion has a size and shape and the compression plate approximates the size and shape of the brim portion.

28. The assembly of claim 16 wherein the tubular portion and the brim portion are both resin impregnable.

29. The assembly of claim 16 wherein the tubular portion is resin impregnable and the brim portion is not resin impregnable.

30. The assembly of claim 16 wherein the tubular portion is made from a material different than a material of the brim portion.

31. An assembly for sealing a junction of a pipe and a second structure comprising:
a pipe liner having a tubular portion;
a compression plate attached to the tubular portion of the pipe liner; and
a mechanical anchor adapted to secure the compression plate to the second structure.

32. The assembly of claim 31, further comprising a gasket for placement between the pipe liner and the pipe or second structure.

33. The assembly of claim 31, wherein the gasket comprises a hydrophilic material or a hydrophobic material.

34. The assembly of claim 32 wherein the gasket is attached to the tubular portion of the pipe liner.

35. The assembly of claim 31 wherein the compression plate comprises a metal.

36. An assembly for sealing a junction of a pipe and a second structure comprising:
a gasket;
a compression plate adjacent to the gasket; and
a mechanical anchor adapted to secure the compression plate to the second structure.

37. The assembly of claim 36, wherein the compression plate includes a tubular portion adapted to be positioned in the pipe and a brim portion adapted to be positioned in the second structure near the junction.

38. The assembly of claim 37 wherein the gasket includes a tubular portion adapted to be positioned in the pipe between the tubular portion of the compression plate and the pipe and a brim portion adapted to be positioned in the second structure between the brim portion of the compression plate and the second structure.

39. The assembly of claim 36, wherein the gasket comprises a compressible material.

40. The assembly of claim 36 wherein the gasket is donut shaped.

41. The assembly of claim 36, wherein the pipe is a lateral sewer pipe and the second structure is a main sewer pipe.

42. The assembly of claim 36 wherein the compression plate comprises a metal.

43. A method of sealing a junction of a pipe and a second structure comprising:
providing a gasket and a compression plate, each having a brim portion;
placing the brim portion of the gasket against an interior wall of the second structure;
placing the brim portion of the compression plate against the brim portion of the gasket; and
securing the compression plate to the second structure using a mechanical anchor.

44. The method of claim 43 wherein the gasket and the compression plate each further include a tubular portion extending from the brim portion.

45. The method of claim 44 further comprising placing the tubular portion of the gasket against an interior wall of the second structure; and
placing the tubular portion of the compression plate against the tubular portion of the gasket.

46. The method of claim 43, wherein the gasket comprises a hydrophilic material, a hydrophobic material, or a compressible material.

47. The method of claim 43, wherein the pipe is a lateral sewer pipe and the second structure is a main sewer pipe.
